(19) United States
(12) Patent Application Publication
(10) Pub. No.: US 2005/0275131 A1
(43) Pub. Date: Dec. 15, 2005

(54) Mechanical interlocking die

(76) Inventors: Travis B. Hoium, Moorhead, MN (US); Brian E. Spiewak, Inver Grove Heights, MN (US); Maria P. Dillon, St. Paul, MN (US); Craig R. Hoff, Corcoran, MN (US); Mark J. Williams, Cottage Grove, MN (US)

Correspondence Address: 3M INNOVATIVE PROPERTIES COMPANY, PO BOX 33427, ST. PAUL, MN, 55133-3427, US

(21) Appl. No.: 10/864,839

(22) Filed: Jun. 9, 2004

(51) Int. Cl. B29C 47/06; B29C 47/30

(52) U.S. Cl. 264/173.17; 425/131.1; 425/133.1

(57) ABSTRACT

A mechanical interlocking die has a first surface, a second surface, a plurality of extrusion features, and a plurality of channels. The first surface and the second surface each extend in a longitudinal direction. Each of the extrusion features includes a base portion extending in a cross-sectional plane from the first surface, wherein the cross-sectional plane is substantially normal to the longitudinal direction, and an arm portion extending at an angle in the cross-sectional plane from the base portion. Each channel extends at an angle to the longitudinal direction from the second surface, and is disposed between a pair of extrusion features.

### CROSS-REFERENCE TO RELATED APPLICATION(S)

The concurrently-filed applications, Attorney Docket No. 59620US002, entitled “Composite Articles and Methods of Making the Same”, and Attorney Docket No. 59652US002, entitled “Composite Article Having a Tie Layer and Method of Making the Same”, are each incorporated herein by reference in their entireties.

### BACKGROUND OF THE INVENTION

The present invention relates to an extrusion die for use with extrusion and molding systems. More particularly, the present invention relates to an extrusion die that mechanically interlocks extruded polymer layers.

Composite articles, such as multi-layered films and tubing, are typically manufactured through extrusion processes, either by sequential extrusions or coextrusions. Based on the design of the extrusion system and the extrusion die(s), a variety of geometric shapes may be obtained. After extrusion, the layers of the composite articles require an adequate level of interlayer adhesion to prevent delamination. This is a concern for composite articles that have bonded layers of different thermoplastic materials, especially if the thermoplastic materials are dissimilar. Dissimilar materials have chemical compositions that exhibit low levels of interlayer adhesion without additional bonding means. An example of dissimilar materials includes a layer of a fluoropolymer and a layer of a conventional non-fluorinated organic polymer. Such layer combinations are typical with a variety of industrial applications, such as fuel line tubing.

Chemical methods, such as tie layers, bonding agents, and chemical modifications have been employed to enhance interlayer adhesion between different materials. For example, tie layers are generally layers of material that exhibit levels of adhesion to both of the dissimilar materials that are greater than the level of adhesion between the dissimilar materials if directly bonded to each other. Nonetheless, these means for enhancing interlayer adhesion typically increase the complexity of processing, the cost of the composite article, and the time and effort to manufacture the composite article. Moreover, such interlayer adhesion means may undesirably reduce the physical and mechanical properties of the composite articles.

In addition to chemical bonding, mechanical fasteners have also been used to prevent interlayer delamination. However, these types of mechanical interactions do not lend themselves well to multi-layer film extrusion processing. As such, significant changes in the extrusion processing are required, which increases time and costs of manufacturing.

There is a continuing need for a means for an enhancing interlayer adhesion of different thermoplastic materials that does not require tie layers, bonding agents, or chemical modifications, and provides for an efficient extrusion process.

### BRIEF SUMMARY OF THE INVENTION

The present invention relates to a mechanical interlocking die that is capable of producing composite articles with mechanically interlocking layers. The mechanical interlocking die includes a plurality of extrusion features and a plurality of channels. Each extrusion feature includes a base portion that extends in a cross-sectional plane from a first surface, and an arm portion that extends at an angle in the cross-sectional plane from the base portion. The cross-sectional plane is substantially normal to a longitudinal direction of the first surface. Each channel extends at an angle to the longitudinal direction from a second surface, and is disposed between a pair of extrusion features. The second surface also extends in the longitudinal direction.

The present invention further relates to a mechanical interlocking die that includes a first surface extending in a longitudinal direction for extruding a first polymer layer and a second surface extending in the longitudinal direction for extruding a second polymer layer. The mechanical interlocking die also includes a plurality of extrusion features and a plurality of channels. Each extrusion feature includes a base portion extending from the first surface, and an arm portion extending at an angle from the base portion. Each channel extends at an angle to the longitudinal direction from the second surface, and is disposed between a pair of extrusion features. The extrusion features produce a plurality of ribs in the longitudinal direction along the first polymer layer. The channels substantially conform portions of the second polymer layer to the ribs. This produces composite articles with mechanically interlocking layers.

The present invention further relates to a method of extruding materials using a mechanical interlocking die, where the mechanical interlocking die includes a plurality of extrusion features and a plurality of channels. Each extrusion feature includes a base portion that extends in a cross-sectional plane from a first surface, and an arm portion that extends at an angle in the cross-sectional plane from the base portion. The cross-sectional plane is substantially normal to a longitudinal direction of the first surface. Each channel extends at an angle to the longitudinal direction from a second surface, and is disposed between a pair of extrusion features. The second surface also extends in the longitudinal direction.

The method includes extruding a portion of a first polymer layer through the extrusion features to form a plurality of ribs, and extruding a portion of a second polymer layer through the channels. This substantially conforms the second material to the ribs, which mechanically interlocks the first polymer layer to the second polymer layer.

### BRIEF DESCRIPTION OF THE DRAWINGS

FIG. 1 is a perspective view of a mechanical interlocking die of the present invention.

FIG. 2A is a perspective view of a mechanical interlocking die of the present invention in use with a die head of an extrusion system.

FIG. 2B is a longitudinal sectional view taken along section 2B-2B in FIG. 2A.

FIG. 2C is a perspective sectional view of a mechanical interlocking die of the present invention in use with an extrusion system.

FIG. 3 is an expanded perspective sectional view of region 3 in FIG. 2C.

FIG. 4 is an enlarged perspective view of a distal end of a mechanical interlocking die of the present invention.

FIG. 5 is a further enlarged front view of a portion of a distal end of a mechanical interlocking die of the present invention.

FIG. 6 is a perspective view of a composite article manufactured with a mechanical interlocking die of the present invention, with portions broken away for illustration.

FIG. 7 is a perspective view of a distal end of a mechanical interlocking die of a second embodiment of the present invention, depicting alternative extrusion features.

FIG. 8 is an enlarged front view of a portion of a distal end of a mechanical interlocking die of the second embodiment of the present invention, depicting alternative extrusion features.

FIG. 9 is a perspective view of a mechanical interlocking die of a third embodiment of the present invention.

FIG. 10 is a rear side view of a mechanical interlocking die of the third embodiment of the present invention.

FIG. 11 is an enlarged front view of a portion of a distal end of a mechanical interlocking die of the third embodiment of the present invention.

FIG. 12 is a perspective view of a mechanical interlocking die of a fourth embodiment of the present invention.

While the above-identified drawings set forth several embodiments of the invention, other embodiments are also contemplated, as noted in the discussion. In all cases, this disclosure presents the invention by way of representation and not limitation. It should be understood that numerous other modifications and embodiments may be devised by those skilled in the art, which fall within the scope and spirit of the principles of the invention. The figures may not be drawn to scale. Like reference numbers have been used throughout the figures to denote like parts.

### DETAILED DESCRIPTION

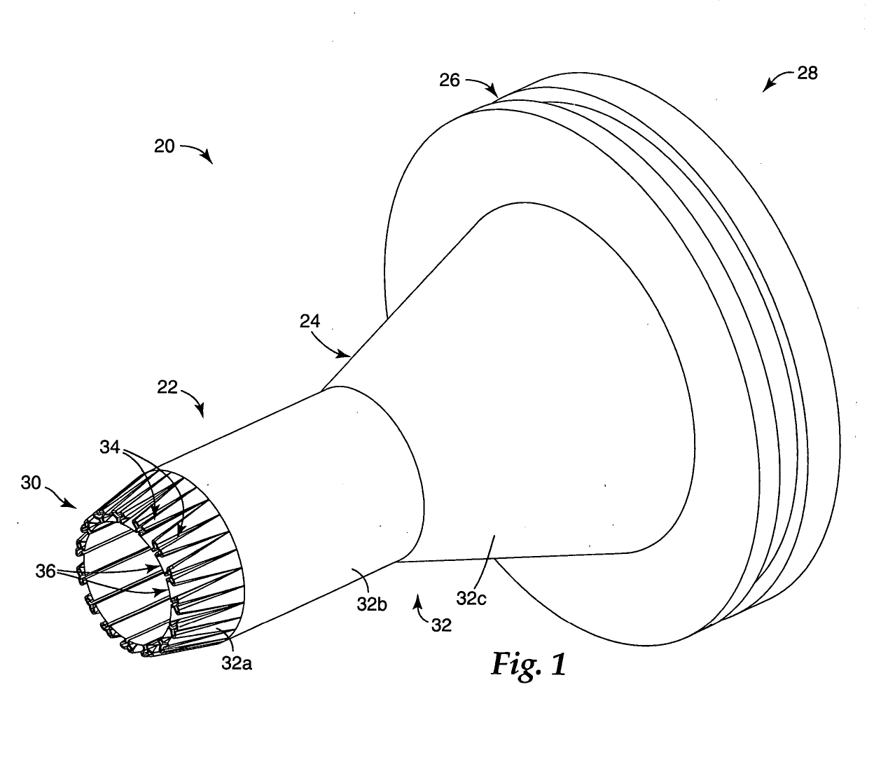

FIG. 1 is a perspective view of a mechanical interlocking die 20 of the present invention, which is capable of producing composite articles with mechanically interlocking layers. The mechanical interlocking die 20 is an annular extrusion die (i.e., a wedge ring), for use with extrusion systems, and includes a feature portion 22, a conical portion 24, a support portion 26, a proximal end 28, and a distal end 30. The feature portion 22 is located at the distal end 30 of the mechanical interlocking die 20 and is connected to the conical portion 24. The feature portion 22 and the conical portion 24 define an outer surface 32, depicted by outer surface portions 32a, 32b, 32c. The conical portion 24 further intersects axially with the support portion 26, where the support portion 26 is located at the proximal end 28 of the mechanical interlocking die 20. The feature portion 22 includes a plurality of extrusion features 34 and a plurality of channels 36 alternating circumferentially around the feature portion 22 at the distal end 30 of the mechanical interlocking die 20. The extrusion features 34 and the channels 36 serve to define and promote the mechanical interlocking of polymer layers extruded with the mechanical interlocking die 20. Composite articles manufactured with the mechanical interlocking provided by the mechanical interlocking die 20 exhibit good interlayer adhesion without requiring tie layers, bonding agents, or chemical modifications.

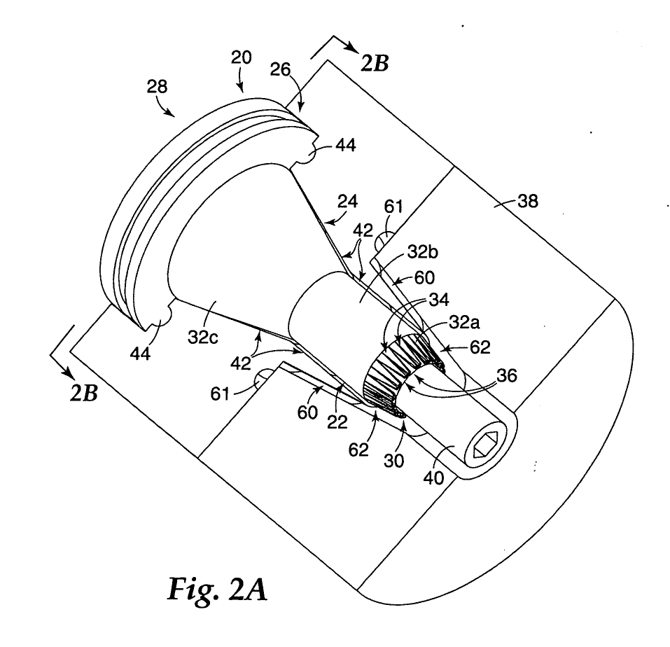

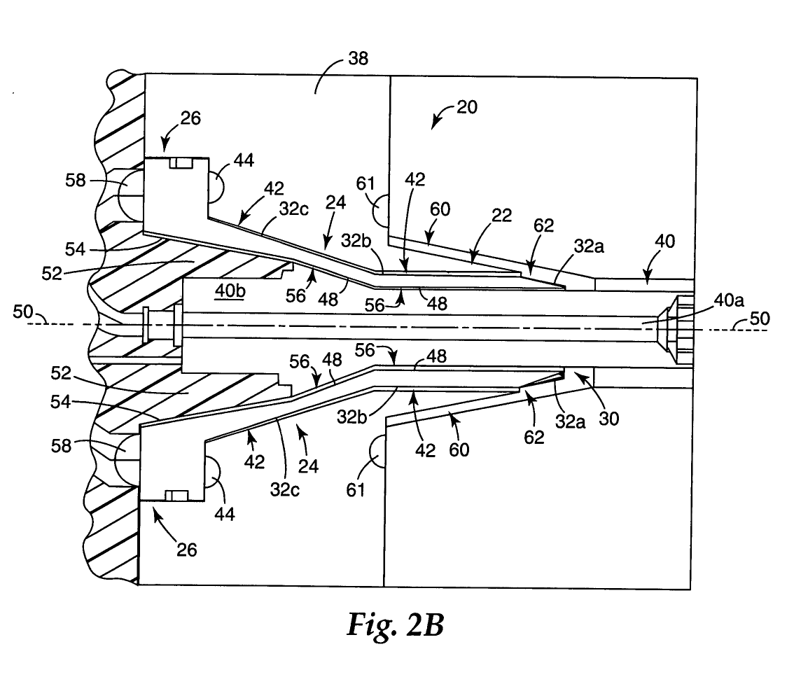

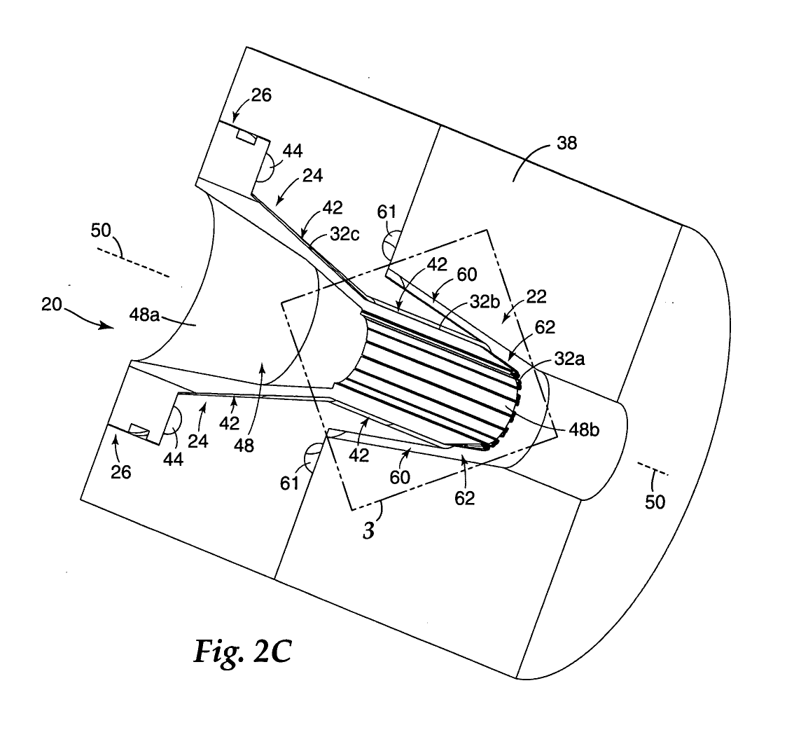

As further illustrated in FIGS. 2A-2C, the mechanical interlocking die 20 may be installed with a variety of systems, including extrusion systems, injection molding systems, and blow molding systems, without requiring significant changes. FIG. 2A illustrates the mechanical interlocking die 20 in use with a die head 38 and an extrusion pin 40 of an extrusion system. The die head 38 is a conventional three-layer die head that engages the remaining portions of the extrusion system (not shown). The die head 38 is depicted in a sectional view to clarify the placement of the mechanical interlocking die 20. FIG. 2B is a longitudinal sectional view taken along section 2B-2B in FIG. 2A (and additionally depicts a portion of the extrusion system). FIG. 2C depicts the mechanical interlocking die 20 in use with the die head 38 as in FIG. 2A (without the extrusion pin 40), where the mechanical interlocking die 20 is depicted sectionally.

The mechanical interlocking die 20 is supported within the die head 38 by the support portion 26. The support portion 26 inserts into the die head 38 in a conventional manner, which positions the mechanical interlocking die 20 such that the outer surface portions 32a, 32b, 32c do not contact the die head 38. Accordingly, the die head 38 and the outer surface portions 32a, 32b, 32c define a first annular pathway 42, which extends circumferentially around the outer surface portions 32a, 32b, 32c, for extruding a first layer. Polymer materials are fed to the first annular pathway 42 from an annular inlet 44 in the die head 38, which connects to the first annular pathway 42.

As best depicted in FIG. 2B, the mechanical interlocking die 20 further includes an inner surface 48 disposed adjacent to the extrusion pin 40. The extrusion pin 40 is a straight extrusion pin, which extends through the mechanical interlocking die 20 along a longitudinal axis 50. The extrusion pin 40 includes a first end 40a that is secured to a socket 52 of the extrusion system, and a second end 40b that extends through the distal end 30 of the mechanical interlocking die 20. The extrusion pin 40 is supported by the socket 52 such that the extrusion pin 40 does not contact the inner surface 48 of the mechanical interlocking die 20. The socket 52 includes an annular wall 54, which is generally located adjacent to the support portion 26 of the mechanical interlocking die 20. The annular wall 54, the extrusion pin 40, and the inner surface 48 of the mechanical interlocking die 20 thereby define a second annular pathway 56, which extends circumferentially around the extrusion pin 40 and the annular wall 54, for extruding a second layer. Polymer materials are fed to the second annular pathway 56 from an annular inlet 58, which connects to the second annular pathway 56.

During a coextrusion process, different polymer materials may flow through the first annular pathway 42 and the second annular pathway 56 toward the distal end 30 of the mechanical interlocking die 20, to produce the first and second layers, respectively. Examples of suitable polymer materials are described in the concurrently-filed applications entitled “Composite Articles and Methods of Making the Same” (Attorney Docket No. 59620US002) and “Composite Article Having a Tie Layer and Method of Making the Same” (Attorney Docket No. 59652US002). As the first and second layers are extruded, the extrusion features 34 and the channels 36 of the feature portion 22 mechanically interlock the first and second layers. The mechanical interlocking of the first and second layers increases interlayer adhesion, which correspondingly reduces, and potentially eliminates, delamination of the composite article. This is particularly useful when extruding dissimilar thermoplastic materials, which otherwise exhibit poor interlayer adhesion.

FIGS. 2A-2C further depict an optional third annular pathway 60 and an annular inlet 61 for extruding a third layer. The first annular pathway 42 and the third annular pathway 60 generally meet at an intersection 62. The third layer may bond to the opposing surface of the first layer from the surface that interacts with the second layer. Polymer materials are fed to the third annular pathway 60 from the annular inlet 61.

As best depicted in FIG. 2C, the inner surface 48 is divided into inner surface portions 48a, 48b. The inner surface portion 48a extends circumferentially within the conical portion 24 and the support portion 26, and provides a generally smooth surface for the second annular pathway 56. The inner surface portion 48b extends circumferentially within the feature portion 22.

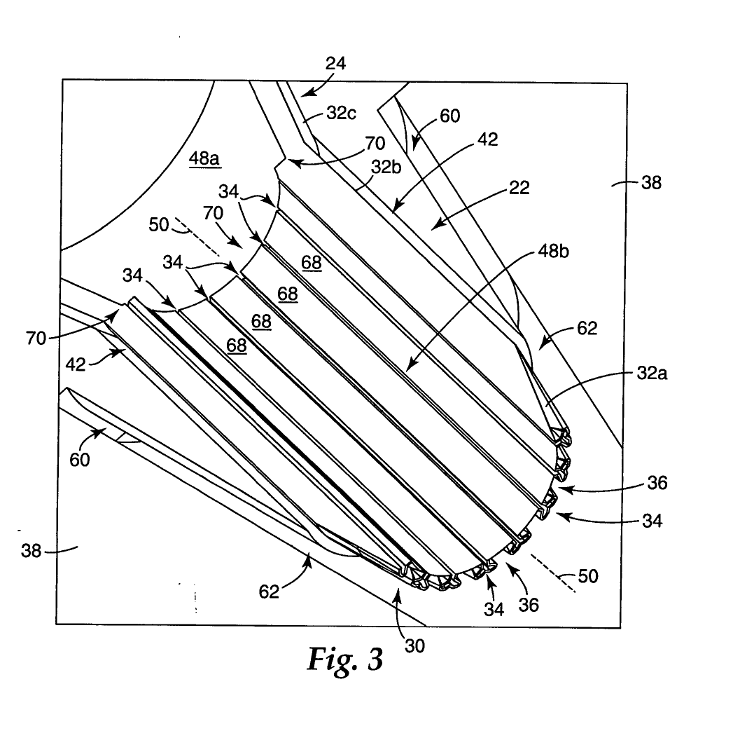

FIG. 3 is an expanded perspective sectional view of region 3 in FIG. 2C. As shown, the inner surface portion 48b includes a plurality of wall segments 68 separated by the extrusion features 34. The wall segments 68 and the extrusion features 34 extend along the inner surface portion 48b in the direction of the longitudinal axis 50.

At an intersection 70 of the inner surface portions 48a, 48b, the wall segments 68 “step up” from the inner surface portion 48a. This “step up”, or annular shoulder, reduces the inner diameter of the inner surface portion 48b relative to the inner diameter of the inner surface portion 48a, and generally directs the second layer in the second annular pathway 56 to flow around the wall segments 68. However, the extrusion features 34 are exposed to the second annular pathway 56 at the intersection 70. While the second layer flows around the wall segments 68, portions of the second layer also flow through the extrusion features 34. This creates a plurality of ribs that extend along the surface of the second layer, where the ribs exhibit cross-sectional shapes defined by the extrusion features 34. The terms “cross-sectional”, “cross-sectionally”, and the like, are defined herein as a plane that is normal to the longitudinal axis 50 of the mechanical interlocking die 20.

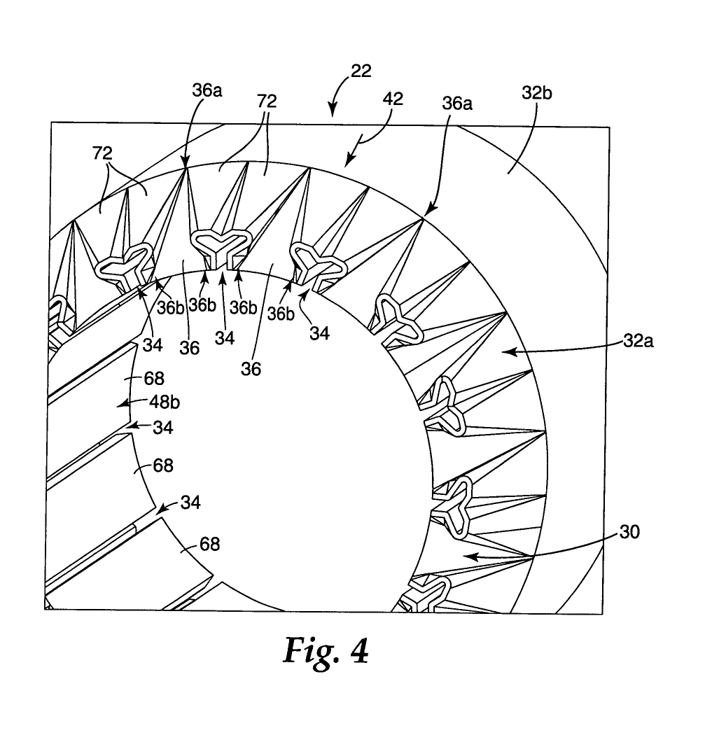

As depicted in FIG. 4, which is an enlarged perspective view of the distal end 30 of the mechanical interlocking die 20, an extrusion feature 34 is disposed on each side of a channel 36, such that the extrusion features 34 and the channels 36 alternate circumferentially around the feature portion 22. The number of extrusion features 34 and channels 36 located around the feature portion 22 may vary as individual needs may require. Suitable numbers for the extrusion features 34 and the channels 36 each range from about four to about 50, with particularly suitable numbers ranging from about five to about 20. In one embodiment, the extrusion features 34 are evenly spaced around the feature portion 22 to maximize the mechanical interlocking of the composite articles.

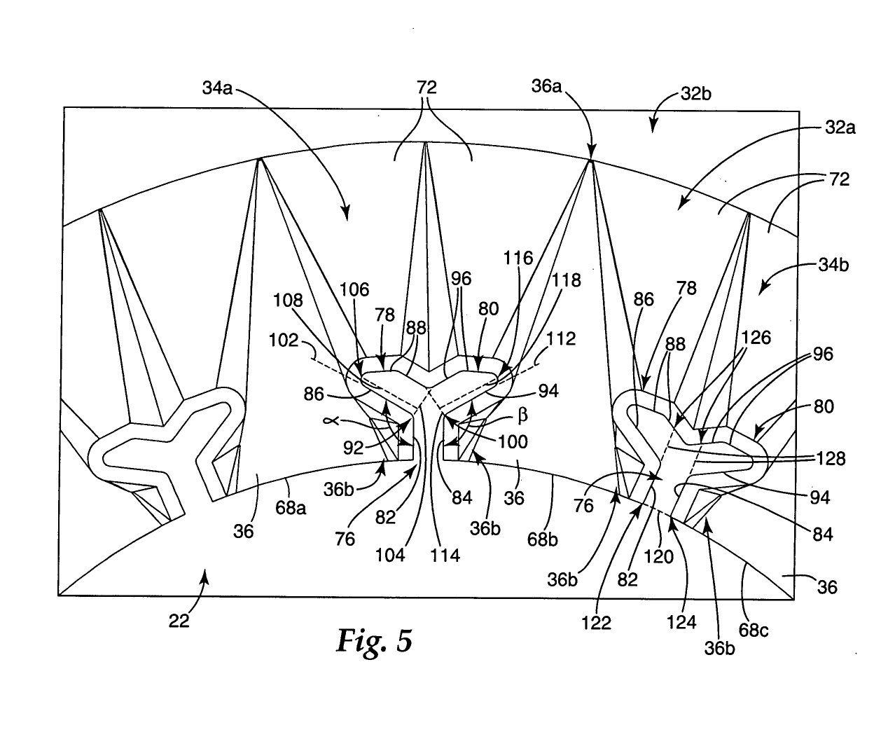

While the second layer extrudes through the second annular pathway 56, the first layer extrudes through the first annular pathway 42 (shown generally by an arrow 42 in FIG. 4) along the outer surface portions 32b, 32c of the mechanical interlocking die 20, toward the distal end 30. As shown in FIGS. 4 and 5, where FIG. 5 is a further enlarged front view of a portion of the distal end 30, the first annular pathway 42 directs a first portion of the first layer to flow over top surfaces 72 of the extrusion features 34 and a second portion to flow into the channels 36. The top surfaces 72 are portions of the outer surface 32a that extend over the extrusion features 34 at the distal end 30. The channels 36 are portions of the outer surface 32a disposed circumferentially between the extrusion features 34. Each channel 36 includes a circumferentially narrow portion 36a adjacent to the outer surface 32b. As the channels 36 extend along the outer surface 32a in the direction of the longitudinal axis 50 toward the distal end 30, each channel 36 circumferentially widens. At the distal end 30, each channel 36 extends below the adjacent extrusion features 34 at points 36b. The second portions of the first layer that flow into the channels 36 expand along with the widening dimensions of the channels 36, and further expand below the extrusion features 34 at the points 36b. As such, the channels 36 direct portions of the first layer to flow between portions of the second layer (i.e., between the surface of the second layer and the portions of the second layer in the extrusion features 34). As the first and second layers exit the mechanical interlocking die at the distal end 30, the first layer substantially conforms to the ribs (formed by the extrusion features 34) and the surface of the second layer. The terms “substantially conforms to”, “substantially conforming to”, and the like, herein are defined as intimately contacting at least 75 percent of the ribs and the surface of the second layer. Upon cooling, the first and second layers form a composite article, where the ribs of the second layer extend into the first layer. This provides a mechanical interlocking of the first and second layers, which increases the interlayer adhesion of the composite article.

The extrusion features of the mechanical interlocking die 20 (e.g., the extrusion features 34) may include a variety of cross-sectional shapes to define the cross-sectional shapes of the ribs of the second layer. Moreover, the individual extrusion features each may exhibit different cross-sectional shapes from other extrusion features of the mechanical interlocking die 20. However, to provide adequate mechanical interlocking, each extrusion feature of the mechanical interlocking die 20 comprises a base portion and at least one arm portion extending at an angle in the cross-sectional plane from the base portion.

FIG. 5 depicts adjacent extrusion features 34a, 34b, which are identical and exemplary of the extrusion features 34 of the mechanical interlocking die 20. In the example depicted in FIG. 5, the extrusion features 34 exhibit “Y”-shaped cross sections. As illustrated by the extrusion feature 34a, each extrusion feature 34 includes a base portion 76 and arm portions 78, 80 extending at angles from the base portion 76. For each extrusion feature 34, the cross-sectional shapes of the base portion 76 and the arm portions 78, 80 are retained along the extrusion feature 34, in the direction of the longitudinal axis 50, to the intersection 70 (shown in FIG. 3). The portion of the second layer that flows through the extrusion feature 34a thereby produces a rib that exhibits a cross-sectional shape defined by the base portion 76 and the arm portions 78, 80.

The base portion 76 is an opening that extends between a pair of wall segments 68 (i.e., wall segments 68a, 68b) of the inner surface portion 48b. The base portion 76 is generally defined by surfaces 82, 84, which extend outward from the wall segments 68a, 68b, respectively, in the cross-sectional plane. While the surfaces 82, 84 are depicted in FIG. 5 as extending in directions essentially normal to the wall segments 68a, 68b, the surfaces 82, 84 may alternatively extend at other angles (e.g., 45 degrees) from the wall segments 68a, 68b in the cross-sectional plane.

The arm portion 78 is an opening that extends at an angle from the base portion 76 in the cross-sectional plane, and is generally defined by a lower surface 86 and an upper surface 88. The lower surface 86 extends at an angle α relative to the surface 82 from an intersection 92 of the surface 82 and the lower surface 86. Examples of suitable angles α relative to the surface 82 range from about 30 degrees to less than about 180 degrees (where 180 degrees is parallel to the surface 82). Examples of particularly suitable angles α relative to the surface 82 range from about 90 degrees to about 135 degrees. As depicted in FIG. 5, the angle α is about 120 degrees from the surface 82.

The arm portion 80 is an opening that also extends at an angle from the base portion 76 in the cross-sectional plane, and is generally defined by a lower surface 94 and an upper surface 96. The lower surface 94 extends at an angle β relative to the surface 84 from an intersection 100 of the surface 84 and the lower surface 94. Examples of suitable angles β relative to the surface 84 range from about 30 degrees to less than about 180 degrees (where 180 degrees is parallel to the surface 84). Examples of particularly suitable angles β relative to the surface 84 range from about 90 degrees to about 135 degrees. The angle β is depicted in FIG. 5 as about 120 degrees from the surface 84.

Because the angles α, β are each about 120 degrees from the surfaces 82, 84, respectively, the extrusion features 34 exhibit cross-sectional “Y” shapes. It is noted, however, that the angle α may alternatively have a different value than the angle β, as individual needs may require. Differing angles α, β correspondingly results in the arm portions 78, 80 extending at different angles from the base portion 76.

Each extrusion feature of the mechanical interlocking die 20 (e.g., the extrusion feature 34) includes a height of the base portion (e.g., the base portion 76) and a total arm length, where the total arm length is the sum of the individual lengths of the arm portions (e.g., the arm portions 78, 80). For mechanically interlocking the first and second layers, at least one of the extrusion features 34 desirably exhibits a total arm length that is greater than the height of the corresponding base portion 76. Moreover, the mechanical interlocking is enhanced if a majority of the extrusion features 34 exhibit total arm lengths that are greater than the heights of the corresponding base portions 76.

The “total arm length”, as used herein, may be calculated by the following method, using references provided in FIG. 5: First, take a planar cross-section through the feature portion 22, which is normal to the longitudinal axis 50 (best depicted in FIG. 3). This provides a sectional view of the type depicted in FIG. 5. Next, referring to the arm portion 78, provide a line 102 that extends from the intersection 92 at the angle α relative to the surface 82. The line 102 is thereby parallel to the lower surface 86. Next, provide a line 104, which also extends from the intersection 92, and is perpendicular to the line 102.

Next, locate a point along the surface of the arm portion 78 (e.g., the lower surface 86 and the upper surface 88) that provides a maximum length for a line that extends perpendicularly from the line 104 (and parallel to the line 102) to the located point. As depicted in FIG. 5, the arm portion 78 has a point 106 that provides the maximum length for a line (i.e., a line 108) between the surface of the arm portion 78 and the line 104, where the line 108 is perpendicular to the line 104. The length of the line 108 between the located point 106 and the line 104 is defined as “the length of the arm portion 78”.

Similarly, for the arm portion 80, provide a line 112 that extends from the intersection 100 at the angle β relative to the surface 84. The line 112 is thereby parallel to the lower surface 94 of the arm portion 80. Next, provide a line 114, which also extends from the intersection 100, and is perpendicular to the line 112.

Next, locate a point along the surface of the arm portion 80 (i.e., the lower surface 94 and the upper surface 96) that provides a maximum length for a line that extends perpendicularly from the line 114 (and parallel to the line 112) to the located point. As depicted in FIG. 5, the arm portion 80 has a point 116 that provides the maximum length for a line (i.e., a line 118) between the surface of the arm portion 80 and the line 114, where the line 118 is perpendicular to the line 114. The length of the line 118 between the located point 116 and the line 114 is defined as “the length of the arm portion 80”.

The “total arm length” for the extrusion feature 34a is then the sum of the length of the arm portion 78 and the length of the arm portion 80. If the extrusion feature 34a only includes a single arm portion, then the total arm length of the extrusion feature 34a is the length of the single arm portion. Alternatively, if the extrusion feature 34a includes more than two arm portions, the total arm length of the extrusion feature 34a is the sum of the lengths of all the arm portions of the extrusion feature 34a.

The extrusion feature 34b incorporates the same references of the extrusion feature 34a, and provides references for calculating the height of the base portion 76. The height of the base portion 76, as used herein, is calculated by the following method: First, using the planar cross-section derived for the total arm length calculation, provide a secant line 120 defined by points 122, 124, where the point 122 is located at an intersection of the surface 82 and the wall segment 68b, and the point 124 is located at an intersection of the surface 84 and the wall segment 68c. As used herein, the terms “vertical”, “vertically”, and the like, refer to a direction that is perpendicular to the secant line 120 and is directed toward the extrusion feature 34b, and the terms “horizontal”, “horizontally”, and the like, refer to a direction that is parallel to the secant line 120.

Next, locate a point along the surface of the extrusion feature 34b (i.e., along the surfaces 82, 84, the lower surfaces 86, 94, and the upper surfaces 88, 96) that provides the maximum length for a line that extends vertically from the secant line 120, horizontally between the points 122, 124, to the located point (without intersecting another point on the surface). Vertical lines from the secant line 120 generally will not intersect lower surfaces 86, 94 without first intersecting surfaces 82, 84, respectively. As depicted in FIG. 5, the extrusion feature 34b has two points 126 that are between the points 122, 124, and provide the maximum length for a vertical line (i.e., lines 128) between the surface of the extrusion feature 34b and the secant line 120. Two points 126 were obtained in FIG. 5 because of the symmetrical shape of the extrusion feature 34b. The length of one of the lines 128 between one of the points 126 and the secant line 120 is defined as “the height of the base portion 76”.

The calculations for the total arm length for the arm portions 78, 80 and the height of the base portion 76, as provided above, are generic methods that are applicable to a variety of cross-sectional shapes for the extrusion features of the mechanical interlocking die 20. For example, if the surfaces 82, 84 of the base portion 76 extended from the wall segments 68a, 68b in the cross-sectional plane at 45 degree angles, the vertical line that extends from the secant line 120 may intersect either the surface 82 or the surface 84, rather than the upper surfaces 88, 96. As such, the height of the base portion would only extend from the secant line to the located point on the surface 82 or the surface 84 of the base portion 76.

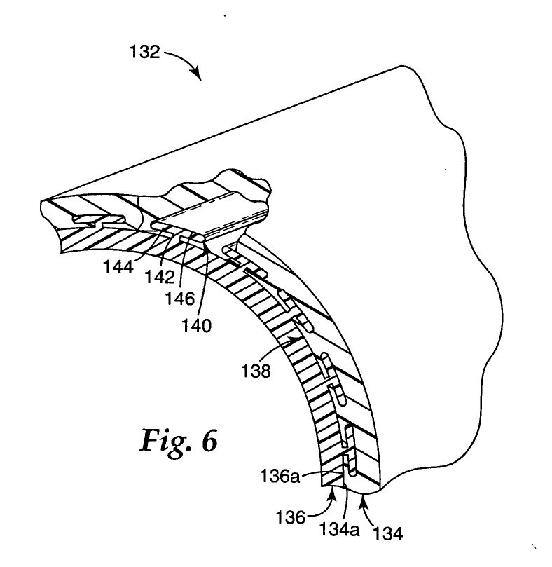

FIG. 6 depicts a perspective view of a composite article 132 coextruded with the mechanical interlocking die 20 having the extrusion features 34 and channels 36 (shown in FIG. 5). The composite article 132 includes a first layer 134 (from the first annular pathway 42) and a second layer 136 (from the second annular pathway 56). The first layer 134 has a surface 134a that engages a surface 136a of the second layer 136 at an interface 138. The second layer 136 further includes a plurality of ribs 140 that extend from the surface 136a into the first layer 134. Each rib 140 includes a wall portion 142 and overhang portions 144, 146. As discussed below, the ribs 140 exhibit cross-sectional “T” shapes rather than the cross-sectional “Y” shapes of the extrusion features 34.

For each rib 140, the wall portion 142 exhibits a height, and the overhang portions 144, 146 each exhibit an overhang width. The concurrently-filed applications, entitled “Composite Articles and Methods of Making the Same” (Attorney Docket No. 59620US002) and “Composite Article Having a Tie Layer and Method of Making the Same” (Attorney Docket No. 59652US002), describe composite articles that may be manufactured using the mechanical interlocking die 20, as well as methods for calculating the overhang widths and the heights of the wall portions 142. As discussed in the concurrently-filed applications, at least one of the overhang widths of the overhang portions 144, 146 is desirably greater than the height of the wall portion 142.

As depicted in FIG. 6, portions of the first layer 134 are disposed beneath the overhang portions 144, 146, adjacent to the wall portions 142 and the surface 136a of the second layer 136. The extrusion features 34 and the channels 36 allow the first layer 134 to substantially conform to the ribs 140 and the surface 136a. In particular, the base portions 76 of the extrusion features 34 create the wall portions 142 of the ribs 140, which offset the corresponding overhang portions 144, 146 from the surface 136a. This allows a greater amount of the first layer 134 to be disposed under the overhang portions 144, 146. The channels 36 of the mechanical interlocking die 20 allow the portions of the first layer 134 to readily flow below the overhang portions 144, 146, and thereby substantially conform to the ribs 140 and the surface 136a. Moreover, the arm portions 78, 80 of the extrusion features exhibit significant total arm lengths (desirably greater than the heights of the corresponding base portions 76). This creates overhang portions 144, 146 that exhibit significant overhang widths to entrap the portions of the first layer 134 disposed below the overhang portions 144, 146. As such, the mechanical interlocking die 20 creates a mechanical interlocking between the first layer 134 and the second layer 136, which reduces the possibility of delamination of the composite article 132.

In comparing FIGS. 5 and 6, it is noted that the ribs 140 produced by the extrusion features 34 exhibit cross-sectional “T” shapes that differ from the cross-sectional “Y” shapes of the extrusion features 34. This is believed to be caused by a general lowering of the overhang portions 144, 146 when the first layer 134 substantially conforms to the ribs 140 and the surface 136a of the second layer 136. The portions of the first layer 134 that flow over the top surfaces 72 of the extrusion features 34 generally press the extruded overhang portions 144, 146 from the angled positions of the arm portions 78, 80 to the cross-sectional shapes provided in FIG. 6 (i.e., from a “Y” shape to a “T” shape). As such, the cross-sectional “Y” shapes of the extrusion features 34 are beneficial for maximizing the overhang widths of the overhang portions 144, 146. Additionally, the first layer may also compress the wall portion 142 toward the surface 136a of the second layer 136. This reduces the height of the wall portion 142 relative to the height of the base portion 76. A variety of factors may affect the extent the overhang portions 144, 146 are lowered and the extent the wall portion 142 is compressed, such as layer compositions, flow rates, viscosities, temperatures, line speeds, and combinations thereof.

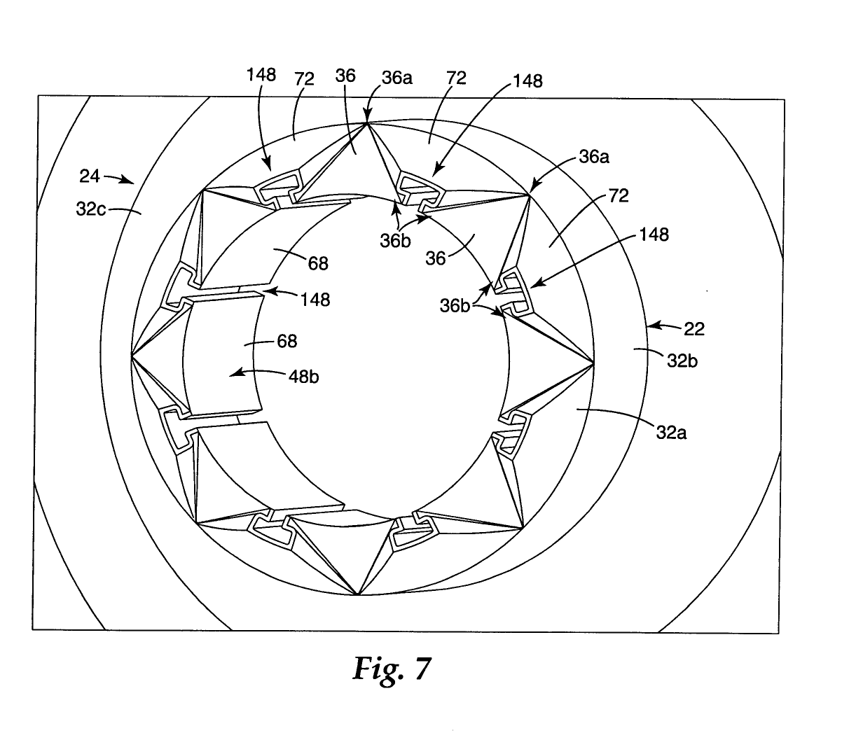

FIG. 7 is a perspective view of the distal end 30 of the mechanical interlocking die 20, illustrating an alternative cross-sectional shape for the extrusion features of the mechanical interlocking die 20, referred to as extrusion features 148. As discussed above, the extrusion features of the mechanical interlocking die 20 may include a variety of cross-sectional shapes so long as each extrusion feature comprises a base portion and at least one arm portion extending at an angle from the base portion. As depicted in FIG. 7, the extrusion features 148 exhibit cross-sectional “T” shapes in lieu of the cross-sectional “Y” shapes of the extrusion features 34. A plurality of extrusion features 148 separate the wall segments 68, where the wall segments 68 and the extrusion features 148 extend along the inner surface portion 48b in the direction of the longitudinal axis 50. For each extrusion feature 148, the cross-sectional “T” shape is retained along the extrusion feature 148 to the intersection 70 (generally shown in FIG. 3). The extrusion features 148 are exposed to the second annular pathway 56 at the intersection 70, allowing portions of the second layer to flow through the extrusion features 148. This results in a plurality of ribs that extend radially outward along the second layer as the second layer is extruded, where the ribs exhibit cross-sectional shapes defined by the extrusion features 148.

An extrusion feature 148 is disposed on each side of a channel 36, such that the extrusion features 148 and the channels 36 alternate circumferentially around the feature portion 22. The first and second layers interact with the channels 36 and the extrusion features 148 in a similar manner as described above for the extrusion features 34. The first annular pathway 42 directs a first portion of the first layer to flow over top surfaces 72 of the extrusion features 148, and a second portion to flow into the channels 36. The top surfaces 72 are portions of the outer surface 32a that extend over the extrusion features 148 at the distal end 30. The channels 36 are portions of the outer surface 32a disposed circumferentially between the extrusion features 148. Each channel 36 includes a circumferentially narrow portion 36a adjacent to the outer surface 32b. As the channels 36 extend along the outer surface 32a in the direction of the longitudinal axis 50 toward the distal end 30, each channel 36 circumferentially widens. At the distal end 30, the channels 36 extend below the extrusion features 148 at points 36b. The second portions of the first layer that flow into the channels 36 expand along with the widening dimensions of the channels 36, and further expand below the extrusion features 148 at the points 36b.

As the first and second layers exit the mechanical interlocking die 20 at the distal end 30, the channels 36 assist the first layer to substantially conform to the ribs (formed by the extrusion features 148) and the surface of the second layer. This results in the ribs of the second layer extending into the first layer, which mechanically interlocks the first and second layers together.

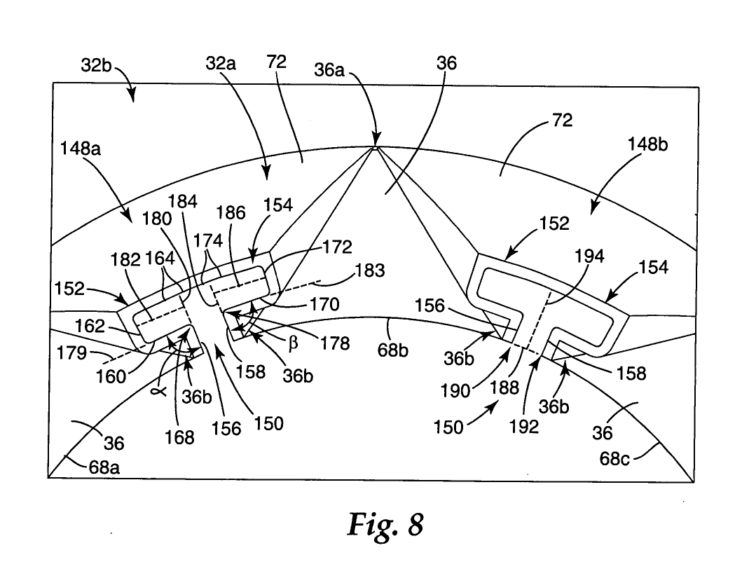

FIG. 8 is an enlarged front view of a portion of the distal end 30 of the mechanical interlocking die 20, illustrating the extrusion features 148a, 148b, which are identical and exemplary of the extrusion features 148 of the mechanical interlocking die 20. As illustrated by the extrusion feature 148a, each extrusion feature 148 includes a base portion 150 and arm portions 152, 154 extending at angles from the base portion 150. Ribs produced by the extrusion features 148 extend along the surface of the second layer, and have cross-sectional shapes defined by the base portions 150 and the arm portions 152, 154.

The base portion 150 is an opening that extends between the wall segments 68a, 68b of the inner surface portion 48b, and is generally defined by surfaces 156, 158, which extend outward from the wall segments 68a, 68b, respectively, in the cross-sectional plane. The arm portion 152 is an opening that extends at an angle from the base portion 150 in the cross-sectional plane, and is generally defined by a lower surface 160, an end surface 162, and an upper surface 164. As described above for the extrusion feature 34, the lower surface 160 extends at an angle α relative to the surface 156 from an intersection 168 of the surface 156 and the lower surface 160. Similarly, the arm portion 154 is an opening that also extends at an angle from the base portion 150 in the cross-sectional plane, and is generally defined by a lower surface 170, an end surface 172, and an upper surface 174. The lower surface 170 extends at an angle β relative to the surface 158 from an intersection 178 of the surface 170 and the lower surface 170.

Examples of suitable angles α relative to the surface 156 range from about 30 degrees to less than about 180 degrees (where 180 degrees is parallel to the surface 156). Examples of particularly suitable angles α relative to the surface 156 range from about 90 degrees to about 135 degrees. Examples of suitable angles β relative to the surface 158 range from about 30 degrees to less than about 180 degrees (where 180 degrees is parallel to the surface 158). Examples of particularly suitable angles β relative to the surface 158 range from about 90 degrees to about 135 degrees. The extrusion feature 148a in FIG. 8 provides an example of alternative angles α, β that the arm portions 152, 154 may respectively extend at. As shown, the angles α, β are each about 90 degrees relative to the surfaces 156, 158, respectively. This creates the cross-sectional “T” shape of the extrusion feature 148a.

Similar to the extrusion features 34, each extrusion feature 148 includes a height of the base portion (e.g., the base portion 150) and a total arm length, where the total arm length is the sum of the individual lengths of the arm portions (e.g., the arm portions 152, 154). The total arm length and the height of the base portion 150 are calculated using the methods described in FIG. 5. First, take a planar cross-section through the feature portion 22, which is normal to the longitudinal axis 50 (best depicted in FIG. 3). This provides a sectional view of the type depicted in FIG. 8. Next, referring to the arm portion 152 in the extrusion feature 148a, provide a line 179 that extends from the intersection 168 at the angle α relative to the surface 156. The line 179 is thereby parallel to the lower surface 160. Next, provide a line 180, which also extends from the intersection 168, and is perpendicular to the line 179.

Next, locate a point along the surface of the arm portion 152 (e.g., the lower surface 160, the end surface 162, and the upper surface 164) that provides a maximum length for a line that extends perpendicularly from the line 180 (and parallel to the line 179) to the located point. As depicted in FIG. 8, because the end surface 162 is parallel to the line 180, any point along the end surface 162 provides the maximum length for such a line (shown randomly by a line 182). As such, the length of the line 182 between the end surface 162 and the line 180 is defined as “the length of the arm portion 152”.

Similarly, for the arm portion 154, provide a line 183 that extends from the intersection 178 at the angle β relative to the surface 158. The line 183 is thereby parallel to the lower surface 170. Next, provide a line 184, which also extends from the intersection 178, and is perpendicular to the line 183.

Next, locate a point along the surface of the arm portion 154 (i.e., the lower surface 170, the end surface 172, and the upper surface 174) that provides a maximum length for a line that extends perpendicularly from the line 184 (and parallel to the line 176) to the located point. As depicted in FIG. 8, because the end surface 172 is parallel to the line 184, any point along the end surface 172 provides the maximum length for such a line (shown randomly by a line 186). The length of the line 186 between the end surface 172 and the line 184 is defined as “the length of the arm portion 154”. The total arm length for the extrusion feature 148a is then the sum of the length of the arm portion 152 and the length of the arm portion 154.

To calculate the height of the base portion 150 (referring to the extrusion feature 148b), first, using the planar cross-section made for the total arm length calculation, provide a secant line 188 defined by points 190, 192, where the point 190 is located at the intersection of the surface 156 and the wall segment 68b, and the point 192 is located at the intersection of the surface 158 and the wall segment 68c. Next, locate a point along the surface of the extrusion feature 148 (i.e., along the surfaces 156, 158, the lower surfaces 160, 170, the end surfaces 162, 172, and the upper surfaces 164, 174) that provides the maximum length for a line that extends vertically from the secant line 188, horizontally between the points 190, 192, to the located point (without intersecting another point on the surface). As depicted in FIG. 8, any point along the upper surfaces 164, 174, which is horizontally between the points 190, 192, provides the maximum length for such a vertical line (shown randomly by a line 194). The length of the line 194 between the upper surface (i.e., the uppers surfaces 164, 174) and the secant line 188 is defined as “the height of the base portion 150”.

For mechanically interlocking the first and second layers, at least one of the extrusion features 148 desirably exhibits a total arm length that is greater than the height of the corresponding base portion 150. Moreover, the mechanical interlocking is enhanced if a majority of the extrusion features 148 exhibit total arm lengths that are greater than the heights of the corresponding base portions 150. As generally discussed in connection with FIG. 6, the ribs 140 produced by the extrusion features 148 may exhibit a general lowering of the overhang portions 144, 146 from the positions of the arm portions 152, 154. The ribs 140 may exhibit a cross-sectional shape similar to an arrowhead, which also entraps portions of the first layer 134 for mechanically interlocking the first and second layers 134, 136.

The mechanical interlocking die 20, as described above, is an example of an mechanical interlocking die of the present invention that is capable of producing composite articles with mechanically interlocking layers. The mechanical interlocking die 20, however, is not intended to be limited to certain dimensions. Due to the varying designs of existing extrusion systems, the required extrusion die dimensions may differ between extrusion systems. As such, various embodiments of the mechanical interlocking die 20 may exhibit different dimensions for compatibility with existing extrusion systems. Particularly, the conical portion 24 and the support portion 26 may be optional components if they are not required for use with a particular extrusion system. Examples of suitable lengths for the mechanical interlocking die 20, in the direction of the longitudinal axis 50, include a length of the feature portion 22 of about 4.6 centimeters (cm), a length of the conical portion 24 of about 4.1 cm, and a length of the support portion 26 of about 1.6 cm.

Examples of suitable outer diameters for the mechanical interlocking die 20, in the cross-sectional plane (i.e., in the radial direction relative to the longitudinal axis 50), include an outer diameter of the feature portion 22 increasing distally to proximally from about 2.3 cm to about 2.7 cm, an outer diameter of the conical portion 24 increasing distally to proximally from about 2.7 cm to about 5.4 cm, and an outer diameter of the support portion 26 of about 8.2 cm. Examples of suitable inner dimensions for the mechanical interlocking die 20, in the cross-sectional plane, include an inner diameter of the feature portion 22 at the inner surface 48b of about 1.9 cm, and inner diameters of the conical portion 24 and the support portion 26 at the inner surface 48a increasing distally to proximally from about 2.3 cm to about 4.8 cm.

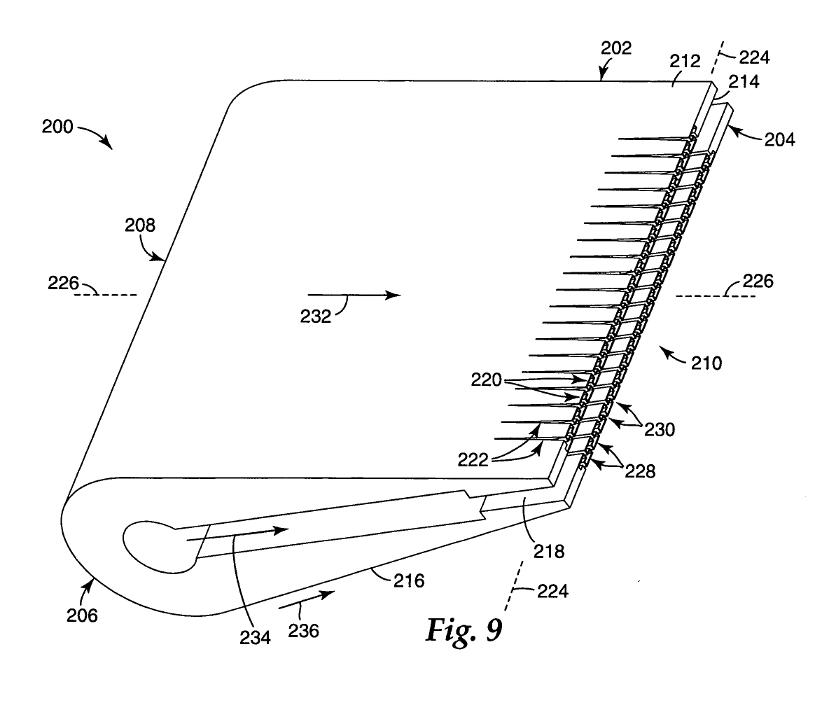

FIG. 9 is a perspective view of a mechanical interlocking die 200, illustrating an alternative embodiment of the present invention to the mechanical interlocking die 20. The mechanical interlocking die 200 produces composite articles with mechanically interlocking layers in the same manner as the mechanical interlocking die 20, except the composite articles are planar films rather than composite tubular articles. As shown, the mechanical interlocking die 200 is a three-layer extrusion die that includes a first feature portion 202, a second feature portion 204, a support portion 206, a proximal end 208, and a distal end 210. The first feature portion 202 and the second feature portion 204 connect with the support portion 206 at the proximal end 208 of the mechanical interlocking die 200, and are generally parallel at the distal end 210. The first feature portion 202 includes an outer surface 212 and an inner surface 214, and the second feature portion 204 includes an outer surface 216 and an inner surface 218.

The first feature portion 202 further includes a plurality of extrusion features 220 and a plurality of channels 222. The extrusion features 220 and the channels 222 alternate across the first feature portion 202 at the distal end 210 of the mechanical interlocking die 200, in a direction of a lateral axis 224. As shown, the lateral axis 224 is perpendicular to a longitudinal axis 226, where the longitudinal axis 226 extends in a direction including the proximal end 208 and the distal end 210 of the mechanical interlocking die 200, and generally represents the direction of flow of polymer materials through the first feature portion 202 and the second feature portion 204. The second feature portion 204 further includes a plurality of extrusion features 228 and a plurality of channels 230. The extrusion features 228 and the channels 230 alternate across the second feature portion 204 at the distal end 210 of the mechanical interlocking die 200, in a direction of the lateral axis 224.

The extrusion features 220, 228 and the channels 222, 230 mechanically interlock polymer layers extruded with the mechanical interlocking die 200 in a similar manner as the extrusion features 148 of the mechanical interlocking die 20. Planar composite articles manufactured with the mechanical interlocking provided by the mechanical interlocking die 200 exhibit good interlayer adhesion without requiring tie layers, bonding agents, or chemical modifications.

The number of extrusion features 220 and channels 222 located along the first feature portion 202 may vary as individual needs may require. Suitable numbers for the extrusion features 220 and the channels 222 each range from about four to about 50, with particularly suitable numbers ranging from about five to about 20. In one embodiment, the extrusion features 220 are evenly spaced along the first feature portion 202 to maximize the mechanical interlocking of the composite articles. Similarly, the number of extrusion features 228 and channels 230 located along the second feature portion 204 may also vary as individual needs may require. Suitable numbers for the extrusion features 228 and the channels 230 each range from about four to about 50, with particularly suitable numbers ranging from about five to about 20. In one embodiment, the extrusion features 228 are evenly spaced along the second feature portion 204 to maximize the mechanical interlocking of the composite articles. The extrusion features 220, 228 may be disposed directly across from each other (as depicted in FIG. 9), staggered, or disposed asymmetrically.

The mechanical interlocking die 200 may also be installed with a variety of systems, including extrusion systems, injection molding systems, and blow molding systems, without requiring significant changes. The outer surface 212 of the first feature portion 202 partially defines a first pathway 232 (depicted by an arrow 232) for extruding a first layer toward the distal end 210. The inner surfaces 214, 218 define a second pathway 234 (depicted by an arrow 234) for extruding a second layer (i.e., a core layer) toward the distal end 210. The outer surface 216 of the second feature portion 204 partially defines a third pathway 236 (depicted by an arrow 236) for extruding a third layer toward the distal end 210.

During a coextrusion process, different polymer materials may flow through the first pathway 232, the second pathway 234, and the third pathway 236 toward the distal end 210, to produce the first, second, and third layers, respectively. Examples of suitable polymer materials are described in the concurrently-filed applications entitled “Composite Articles and Methods of Making the Same” (Attorney Docket No. 59620US002) and “Composite Article Having a Tie Layer and Method of Making the Same” (Attorney Docket No. 59652US002). As the first and second layers are extruded, the extrusion features 220 and the channels 222 of the first feature portion 202 mechanically interlock the first and second layers. Similarly, as the third layer is extruded with the second layer, the extrusion features 228 and the channels 230 of the second feature portion 204 mechanically interlock the second and third layers. The mechanical interlocking of the layers is performed in the same manner as described above for the mechanical interlocking die 20. This increases interlayer adhesion, which correspondingly reduces, and potentially eliminates, delamination of the composite article.

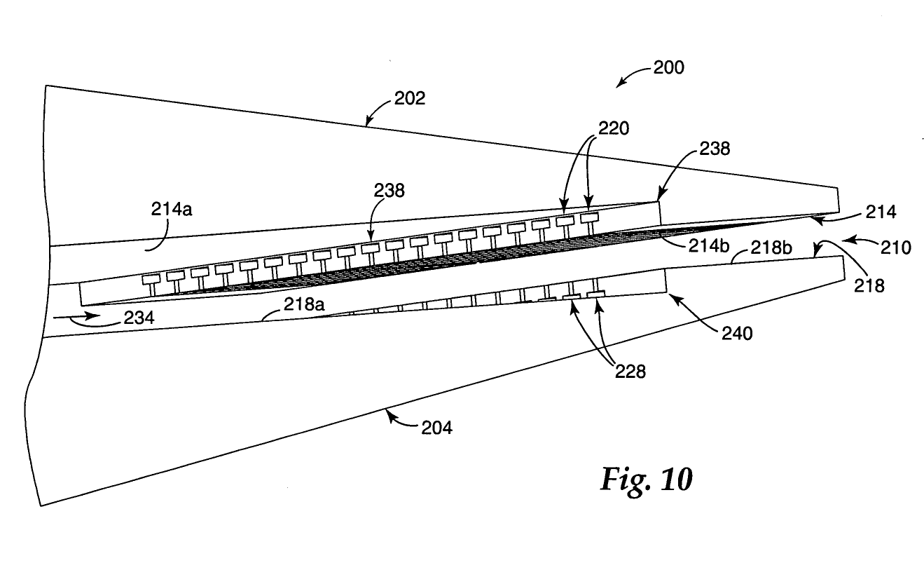

FIG. 10 is a rear side view of the mechanical interlocking die 200 depicting the inner surfaces 214, 218. The inner surface 214 is divided into inner surface portions 214a, 214b, and the inner surface 218 is divided into inner surface portions 218a, 218b. The inner surface portions, 214a, 218a are disposed between the proximal end 208 (not shown) and the distal end 210, and provide generally smooth surfaces for the second pathway 234. The inner surface portions 214b, 218b are disposed near the distal end 210. As shown in FIG. 10, the inner surface portion 214b “steps up” at an intersection or shoulder 238 of the inner surface portions 214a, 214b, and the inner surface portion 218b “steps up” at an intersection or shoulder 240 of the inner surface portions 218a, 218b. These “steps up” correspond to the “step up” or annular shoulder defined between the inner surface portions 48a, 48b of the mechanical interlocking die 20, previously discussed in FIG. 3. Each “step up” reduces the distance between the inner surfaces 214, 218. This correspondingly reduces the dimensions of the second pathway 234, and generally directs the second layer in the second pathway 234 to flow around the inner surface portions 214b, 218b.

As shown, the extrusion features 220 are exposed to the second pathway 234 at the intersection 238. While the second layer flows around the inner surface portion 214b, portions of the second layer also flow through the extrusion features 220. This creates a first set of ribs that extend along the surface of the second layer (facing the first layer), where the first set of ribs exhibit cross-sectional shapes defined by the extrusion features 220. The extrusion features 228 are also exposed to the second pathway 234 at the intersection 240. While the second layer flows around the inner surface portion 218b, portions of the second layer also flow through the extrusion features 228. This creates a second set of ribs that extend along the surface of the second layer (facing the third layer), where the second set of ribs exhibit cross-sectional shapes defined by the extrusion features 228.

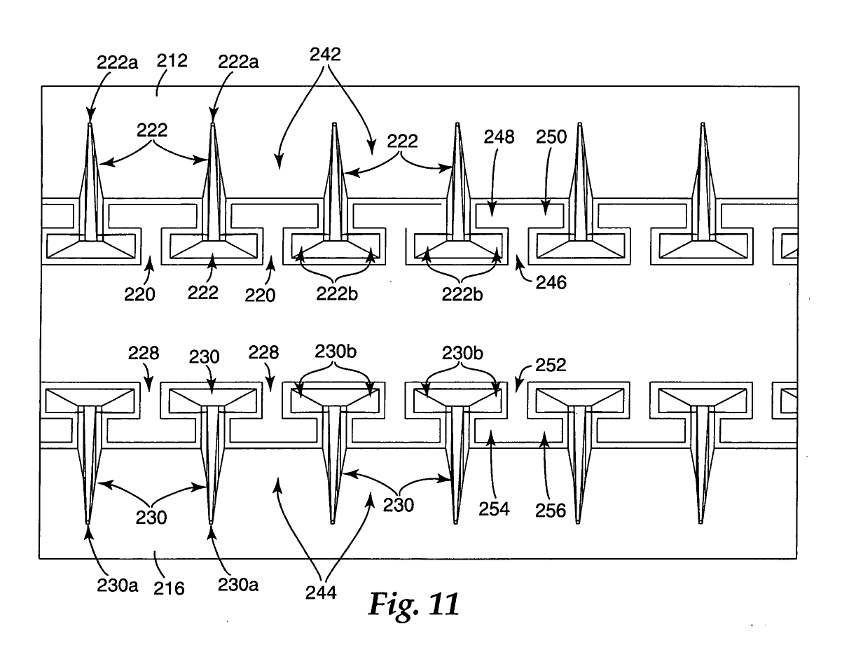

FIG. 11 is an enlarged front view of a portion of the distal end 210 of the mechanical interlocking die 200, illustrating the extrusion features 220, 228 and the channels 222, 230. As shown, the extrusion features 220, 228 exhibit cross-sectional “T” shapes, which correspond to the extrusion features 148 previously described in FIG. 8. However, the extrusion features 220, 228 are not required to uniformly exhibit the same cross-sectional shapes. For example, the extrusion features 220 may exhibit cross-sectional “T” shapes while the extrusion features 228 may exhibit cross-sectional “Y” shapes. Moreover, the individual extrusion features 220 extending along the first feature portion 202 each may exhibit different cross-sectional shapes (this principle also applies to the extrusion features 228).

The first and second layers interact with the extrusion features 220 and the channels 222, and the second and third layers interact with the extrusion features 228 and the channels 230, in similar manners as described above in FIGS. 7 and 8 for the extrusion features 148 and the channels 36 of the mechanical interlocking die 20. This produces a planar composite article that exhibits mechanical interlocking between the first and second layers, and between the second and third layers.

As shown in FIG. 11, an extrusion feature 220 is disposed on each side of a channel 222, such that the extrusion features 220 and the channels 222 alternate laterally along the first feature portion 202. While the second layer extrudes through the second pathway 234, the first layer extrudes through the first pathway 232 along the outer surface 212, toward the distal end 210. The first pathway 232 directs a first portion of the first layer to flow over top surfaces 242 of the extrusion features 220 and a second portion to flow into the channels 222. The top surfaces 242 are portions of the outer surface 212 that extend over the extrusion features 220 at the distal end 210. The channels 222 are portions of the outer surface 212 disposed laterally between the extrusion features 220. Each channel 222 includes a laterally narrow portion 222a at a location furthest from the distal end 210. As the channels 222 extend along the outer surface 212 in the direction of the longitudinal axis 226 toward the distal end 210, each channel 222 laterally widens. At the distal end 210, the channels 222 extend below the extrusion features 220 at points 222b.

The second portions of the first layer that flow into the channels 222 expand along with the widening dimensions of the channels 222, and further expand below the extrusion features 220 at the points 222b. As such, the channels 222 direct portions of the first layer to flow between portions of the second layer (i.e., between the surface of the second layer and the portions of the second layer in the extrusion features 220).

An extrusion feature 228 is also disposed on each side of a channel 230, such that the extrusion features 228 and the channels 230 alternate laterally along the second feature portion 204. While the second layer extrudes through the second pathway 234, the third layer extrudes through the third pathway 236 along the outer surface 216, toward the distal end 210. The third pathway 236 directs a first portion of the third layer to flow over top surfaces 244 of the extrusion features 228 and a second portion to flow into the channels 230. As shown in FIG. 11, the extrusion features 228 and the channels 230 are directionally inverted relative to the extrusion features 220 and the channels 222. However, for consistency, the same directional terminology will be applied to both (e.g., “over”, “below”, etc . . . ). The top surfaces 244 are portions of the outer surface 216 that extend over the extrusion features 228 at the distal end 210. The channels 230 are portions of the outer surface 216 disposed laterally between the extrusion features 228. Each channel 230 includes a laterally narrow portion 230a at a location furthest from the distal end 210. As the channels 230 extend along the outer surface 216 in the direction of the longitudinal axis 226 toward the distal end 210, each channel 230 laterally widens. At the distal end 210, the channels 230 extend below the extrusion features 228 at points 230b.

The second portions of the third layer that flow into the channels 230 expand along with the widening dimensions of the channels 230, and further expand below the extrusion features 228 at the points 230b. As such, the channels 230 direct portions of the third layer to flow between portions of the second layer (i.e., between the surface of the second layer and the portions of the second layer in the extrusion features 228).

As the first, second, and third layers exit the mechanical interlocking die 200 at the distal end 210, the first layer substantially conforms to the first set of ribs (formed by the extrusion features 220) and the surface of the second layer, and the third layer substantially conforms to the second set of ribs (formed by the extrusion features 228) and the opposing surface of the second layer. Upon cooling, the first, second, and third layers form a planar composite article, where the first set of ribs extend into the first layer, and the second set of ribs extend into the third layer. This provides a mechanical interlocking of the first and second layers, and of the second and third layers, which increase the interlayer adhesion of the composite article.

The extrusion features of the mechanical interlocking die 200 (e.g., the extrusion features 220, 228) may include a variety of cross-sectional shapes to define the cross-sectional shapes of the first and second sets of ribs. As with the extrusion features of the mechanical interlocking die 20, each extrusion feature of the mechanical interlocking die 200 comprises a base portion and at least one arm portion extending at an angle from the base portion. As shown in FIG. 1, the extrusion features 220, 228 are the same as the extrusion features 148 of the mechanical interlocking die 20, previously discussed in FIGS. 7 and 8. Each extrusion feature 220 includes a base portion 246 and arm portions 248, 250 extending at angles from the base portion 246. For each extrusion feature 220, the cross-sectional shapes of the base portion 246 and the arm portions 248, 250 are retained along the extrusion feature 220, in the direction of the longitudinal axis 226, to the intersection 238 (shown in FIG. 10). The portions of the second layer that flow through the extrusion features 220 thereby produce a first set of ribs that exhibit cross-sectional shapes defined by the base portion 246 and the arm portions 248, 250.

Similarly, each extrusion feature 228 includes a base portion 252 and arm portions 254, 256 extending at angles from the base portion 252. For each extrusion feature 228, the cross-sectional shapes of the base portion 252 and the arm portions 254, 256 are retained along the extrusion feature 228, in the direction of the longitudinal axis 226, to the intersection 240 (shown in FIG. 10). The portions of the second layer that flow through the extrusion features 228 thereby produce a second set of ribs that exhibit cross-sectional shapes defined by the base portion 252 and the arm portions 254, 256.

Each extrusion feature of the mechanical interlocking die 200 includes a height of the base portion and a total arm length, where the total arm length is the sum of the individual lengths of the arm portions. For the extrusion features 220, 228, the total arm lengths and the heights of the base portions are calculated using the methods described in FIG. 5, and have results as discussed for the extrusion features 148 in FIG. 8. For mechanically interlocking the first, second, and third layers, at least one of the extrusion features 220 desirably exhibits a total arm length that is greater than the height of the corresponding base portion 246, and at least one of the extrusion features 228 desirably exhibits a total arm length that is greater than the height of the corresponding base portion 252. Moreover, the mechanical interlocking is enhanced if a majority of the extrusion features 220 exhibit total arm lengths that are greater than the heights of the corresponding base portions 246, and a majority of the extrusion features 228 exhibit total arm lengths that are greater than the heights of the corresponding base portions 252.

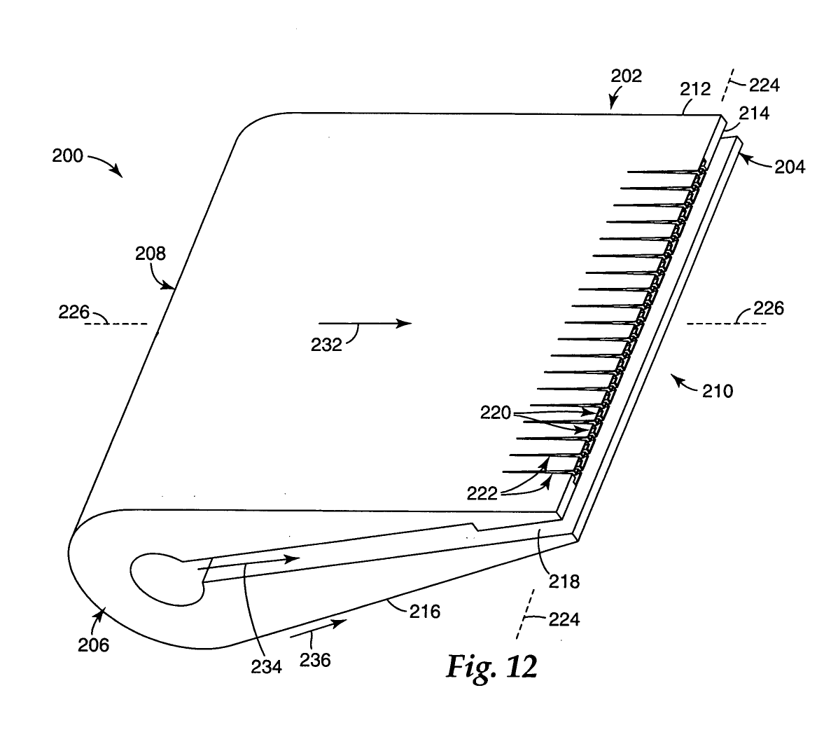

In an alternative embodiment of the mechanical interlocking die 200, depicted in FIG. 12, the extrusion features and the channels may exist on only one of the feature portions (i.e., the first feature portion 202). In this embodiment, the second feature portion 204 is a smooth surface and does not contain any extrusion features or channels. This is useful if only two layers are being extruded or if mechanical interlocking is not desired between the second and third layers. The third layer may chemically bond to the opposing surface of the second layer from the surface interacting with the first layer.

The mechanical interlocking dies of the present invention may produce a variety of shapes for extruded multi-layer articles. In addition to embodiments described above (i.e., the mechanical interlocking die 20 for tubular composite articles and the mechanical interlocking die 200 for planar composite articles), examples of suitable extrusion shapes include “L”-shaped films, arched films, “U”-shaped films, irregular-shaped films, waved films, cylindrical composite articles, rectangular-shaped films, and other geometrically-shaped composite articles that are extrudable.

The heights of the base portions for the extrusion features (e.g., the extrusion features 34, 148, 220, 228) may vary as individual needs require. In particular, parameters such as layer thickness, the number of extrusion features, and the diameter of the composite article, may dictate the required heights. However, the heights desirably are small enough so that the ribs formed by the extrusion features do not penetrate through the first layer. Examples of suitable heights of the base portions for the extrusion features of the mechanical interlocking dies 20, 200 include heights less than about 25.0 mm, with particularly suitable heights less than about 10.0 mm. However, for use with very thin layers, the height of the base portions may even be less than 0.5 mm. The corresponding arm portions desirably exhibit total arm lengths that are greater than the heights of the base portions, and may be dictated by parameters such as the number of extrusion features and the diameter of the composite article.

The mechanical interlocking dies 20, 200 are generally cast from 15/5 steel. The extrusion features are then formed by wire electric discharge machining (EDM) to define the extrusion features. Similarly, the channels are formed by sinker EDM to define the channels.

In addition to coextruding the polymer layers, as described above for the tubular and planar composite articles, the polymer layers may alternatively be manufactured in separate steps (e.g., a sequential extrusion process). The second layer may be extruded in a first step, using a mechanical interlocking die of the present invention to form ribs extending from the surface of the second layer, where the ribs have cross-sectional shapes defined by the extrusion features of the mechanical interlocking die. Then, in a second step, the first layer (and third layer, if used) is coated onto the second layer to substantially conform to the ribs and the surface of the second layer. Coating may be performed by conventional manners such as extruding the first layer over the profiled second layer through a cross-head die. This also mechanically interlocks the first and second layers. However, coextrusion allows a single-step manufacturing, which simplifies startup and control of the line, and also provides greater quality control over the composite article.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“THV 500”: A fluorinated terpolymer commercially available from Dyneon, LLC of Oakdale, Minn., under the trade designation “Dyneon THV 500 Fluorothermoplastic”.
“THV 815”: A fluorothermoplastic commercially available from Dyneon, LLC of Oakdale, Minn., under the trade designation “Dyneon THV 815 Fluorothermoplastic”.
“VFEPX 6815G”: A fluorothermoplastic commercially available from Dyneon, LLC of Oakdale, Minn., under the trade designation “Dyneon VFEPX 6815G Fluorothermoplastic”.
“Ultramid B3”: A polyamide (nylon) 6 commercially available from BASF Corp. of Mount Olive, N.J., under the trade designation “Ultramid B3”.
“EMS L25W40X”: A polyamide (nylon) 12 commercially available from EMS-Chemie N.A., Inc. of Sumter S.C., under the trade designation “Grilamid L25W40X”.

### Example 1

Example 1 is a three-layer tubular composite article that was coextruded with a mechanical interlocking die of the present invention. The mechanical interlocking die exhibited dimensions as described above for the mechanical interlocking die 20, and included extrusion features exhibiting cross-sectional “Y” shapes, as described above for the extrusion features 34.

The inner tubular layer consisted of THV 815 and was extruded with the mechanical interlocking die of the present invention from a 3.8-cm (1.5-inch) Harrel Single Screw Extruder, commercially available from Harrel, Inc. of East Norwalk, Conn., having a length-to-diameter ratio of 26, and a temperature profile of 255/275/285° C. The extrusion created ribs extending radially along the inner tubular layer.

The middle layer consisted of EMS L25W40X, and each was extruded with the mechanical interlocking die of the present invention from a 2.5-cm (1-inch) Harrel Single Screw Extruder, commercially available from Harrel, Inc. of East Norwalk, Conn., having a length-to-diameter ratio of 26, and a temperature profile of 180/195/210° C.

The outer tubular layer consisted of EMS L25W40X, and each was extruded with the mechanical interlocking die of the present invention from a 5.1-cm (2-inch) Harrel Single Screw Extruder, commercially available from Harrel, Inc. of East Norwalk, Conn., having a length-to-diameter ratio of 26, and a temperature profile of 180/195/210° C. The outer tubular layer did not directly interact with the mechanical interlocking die of the present invention. Because the middle and outer tubular layers consisted of the same polymer, the tubular composite article of Example 1 effectively functioned as a two-layer composite article.

The resulting tubular composite article of Example 1 was quenched in a water bath, fed through web handling equipment, and rolled up with a line speed of 3.4 meters-per-minute (11 feet-per-minute).

### Example 2

Example 2 is a three-layer tubular composite article that was coextruded pursuant to the procedure described in Example 1, except that the inner tubular layer consisted of VFEPX 6815G instead of THV 815.

### Example 3

Example 3 is a three-layer tubular composite article of Example 2, which was coextruded pursuant to the procedure described in Example 1, except that the line speed was 10.1 meters-per-minute (33 feet-per-minute).

### Example 4

Example 4 is a three-layer tubular composite article of Examples 2 and 3, which was coextruded pursuant to the procedure described in Example 1, except that the line speed was 15.5 meters-per-minute (51 feet-per-minute).

### Example 5

Example 5 is a three-layer tubular composite article that was coextruded with a mechanical interlocking die of the present invention. The mechanical interlocking die exhibited dimensions as described above for the mechanical interlocking die 20, and included extrusion features exhibiting cross-sectional “T” shapes, as described above for the extrusion features 148.

The inner tubular layer consisted of THV 500 and was extruded with the mechanical interlocking die of the present invention from a 3.8-cm (1.5-inch) Harrel Single Screw Extruder, having a length-to-diameter ratio of 26, and a temperature profile of 255/275/285° C. The extrusion created ribs extending radially along the inner tubular layer.

The middle and outer tubular layers each consisted of Ultramid B3, and each was extruded with the mechanical interlocking die of the present invention from a 5.1-cm (2-inch) Harrel Single Screw Extruder, having a length-to-diameter ratio of 26, and a temperature profile of 180/195/210° C. The outer tubular layer did not directly interact with the mechanical interlocking die of the present invention. Because the middle and outer tubular layers consisted of the same polymer, the tubular composite article of Example 5 effectively functioned as a two-layer composite article.

The resulting tubular composite article of Example 5 was quenched in a water bath, fed through web handling equipment, and rolled up with a line speed of 3.7 meters-per-minute (12 feet-per-minute).

### Example 6

Example 6 is a three-layer tubular composite article of Example 5, which was also coextruded pursuant to the procedure described in Example 5, except that the line speed was 9.1 meters-per-minute (30 feet-per-minute).

### Example 7

Example 7 is a three-layer tubular composite article of Example 5, which was also coextruded pursuant to the procedure described in Example 5, except that the line speed was 12.2 meters-per-minute (40 feet-per-minute).

### Example 8

Example 8 is a three-layer tubular composite article of Example 5, which was also coextruded pursuant to the procedure described in Example 5, except that the line speed was 14.6 meters-per-minute (48 feet-per-minute).

Peel Strength Tests for Examples 1-8

The composite articles of Examples 1-8 were tested for peel strengths pursuant to ASTM D1876 on an Instron Model 5564 with a cross-head speed of 150 mm/minute. The Instron Model 5564 is commercially available from Instron Corp. of Canton, Mass. Table 1 provides the peel strength results for Examples 1-8.

TABLE 1

| | | | Line Speed | | |
|---|---|---|---|---|---|
| | | Middle and | (meters- | Peel strength | Standard |
| | Inner Layer | Outer Layers | per-minute) | (N/cm) | Deviation (N/cm) |
| Example 1 | THV 815 | EMS L25W40X | 3.4 | 13.9 | 2.7 |
| Example 2 | VFEPX 6815G | EMS L25W40X | 3.4 | 15.3 | 2.0 |
| Example 3 | VFEPX 6815G | EMS L25W40X | 10.1 | 15.9 | 0.8 |
| Example 4 | VFEPX 6815G | EMS L25W40X | 15.5 | 15.6 | 3.0 |
| Example 5 | THV 500 | Ultramid B3 | 3.7 | 9.7 | 0.8 |
| Example 6 | THV 500 | Ultramid B3 | 9.1 | 8.3 | 0.7 |
| Example 7 | THV 500 | Ultramid B3 | 12.2 | 7.1 | 0.8 |
| Example 8 | THV 500 | Ultramid B3 | 14.6 | 6.0 | 0.5 |

The inner layers of the composite articles of Examples 1-8 consisted of fluoropolymers (i.e., THV 815, VFEPX 6815G, and THV 500). In contrast, the middle (and outer) layers consisted of nylon polymers (i.e., EMS L25W40X and Ultramid B3). The fluoropolymers and nylon polymers are dissimilar materials that generally exhibit poor interlayer adhesion. Without assistance (e.g., a chemical or mechanical interlocking of the dissimilar materials), composite articles with such layers exhibit negligible peel strengths. However, as shown in Table 1, the composite articles of Examples 1-8 exhibit peel strengths from about 6.0 N/cm to about 16 N/cm. This is due to the mechanical interlocking of the ribs formed by the mechanical interlocking dies of the present invention.

As shown, the composite articles of Examples 5-8 generally exhibited lower peel strengths than the composite articles of Examples 14. This was believed to be due to deformations in the ribs of the composite articles of Examples 5-8. The “T” shapes were substantially compressed, which resulted in lower amounts of mechanical interlocking between the layers. Nonetheless, the composite articles of Examples 5-8 still exhibited adequate levels of interlayer adhesion, which were superior to similar composite articles without mechanical interlocking.

Although the present invention has been described with reference to preferred embodiments, workers skilled in the art will recognize that changes may be made in form and detail without departing from the spirit and scope of the invention.

1. A mechanical interlocking die comprising:
a first surface and a second surface, the first surface and the second surface extending in a longitudinal direction;
a plurality of extrusion features, each of the extrusion features comprising:
a base portion extending in a cross-sectional plane from the first surface, wherein the cross-sectional plane is substantially normal to the longitudinal direction; and
an arm portion extending at an angle in the cross-sectional plane from the base portion; and
a plurality of channels, each channel extending at an angle to the longitudinal direction from the second surface, and wherein each channel is disposed between a pair of extrusion features.

2. The mechanical interlocking die of claim 1, wherein at least one of the extrusion features further extends in the longitudinal direction, wherein the extrusion feature exhibits a cross-sectional shape in the cross-sectional plane, the cross-sectional shape being defined by the base portion and the arm portion, and wherein the extrusion feature substantially retains the cross-sectional shape along the longitudinal direction.

3. The mechanical interlocking die of claim 1, wherein at least one of the channels exhibits a cross-sectional width in the cross-sectional plane, wherein the cross-sectional width is narrowest at an intersection of the channel and the second surface, and wherein the cross-sectional width increases along the longitudinal direction.

4. The mechanical interlocking die of claim 1, wherein a portion of one of the channels extends between the arm portion of at least one of the extrusion features and the first surface.

5. The mechanical interlocking die of claim 1, wherein for at least one of the extrusion features, the base portion comprises a height and the arm portion comprises a total arm length, wherein the total arm length is greater than the height of the base portion.

6. The mechanical interlocking die of claim 1, wherein for at least one of the extrusion features, the arm portion extends from the base portion at angle ranging from about 90 degrees to less than about 180 degrees, relative to the base portion.

7. The mechanical interlocking die of claim 6, wherein the arm portion extends from the base portion at angle ranging from about 90 degrees to about 135 degrees, relative to the base portion.

8. The mechanical interlocking die of claim 1, wherein the first surface and the second surface are annular.

9. The mechanical interlocking die of claim 1, wherein the first surface and the second surface are aligned to define a flow path that produces a planar film.

10. The mechanical interlocking die of claim 1, wherein the height of the base portion of each of the extrusion features is less than or equal to about 10.0 millimeters.

11. The mechanical interlocking die of claim 1, wherein for at least one of the extrusion features, the arm portion is a first arm portion, and wherein the extrusion feature further comprises a second arm portion extending at a second angle in the cross-sectional plane from the base portion.

12. The mechanical interlocking die of claim 11, wherein the first arm portion comprises a first length, wherein the second arm portion comprises a second length, wherein the base portion comprises a height, and wherein a sum of the first length and the second length is greater than the height of the base portion.

13. The mechanical interlocking die of claim 11, wherein the second angle is the same as the angle of the first arm portion, and wherein the second arm portion extends from the base portion in an opposite direction from the first arm portion.

14. The mechanical interlocking die of claim 13, wherein the extrusion feature comprising the first arm portion and the second arm portion substantially defines a T shape in the cross-sectional plane.

15. The mechanical interlocking die of claim 13, wherein the extrusion feature comprising the first arm portion and the second arm portion substantially defines a Y shape in the cross-sectional plane.

16. A mechanical interlocking die comprising:
a first surface extending in a longitudinal direction for extruding a first polymer layer;
a second surface extending in the longitudinal direction for extruding a second polymer layer;
a plurality of extrusion features for producing a plurality of ribs in the longitudinal direction along the first polymer layer, each extrusion feature comprising a base portion extending from the first surface, and an arm portion extending at an angle from the base portion; and
a plurality of channels for substantially conforming portions of the second polymer layer to the ribs, each channel extending at an angle to the longitudinal direction from the second surface, and wherein each channel is disposed between a pair of extrusion features.

17. The mechanical interlocking die of claim 16, wherein the base portions of each extrusion feature extends in a cross-sectional plane from the first surface, wherein the arm portion of each extrusion feature extends at an angle in the cross-sectional plane from the base portion, and wherein the cross-sectional plane is substantially normal to the longitudinal direction.

18. The mechanical interlocking die of claim 17, wherein at least one of the extrusion features further extends in the longitudinal direction, wherein the extrusion feature exhibits a cross-sectional shape in the cross-sectional plane, the cross-sectional shape being defined by the base portion and the arm portion, and wherein the extrusion feature substantially retains the cross-sectional shape along the longitudinal direction.

19. The mechanical interlocking die of claim 17, wherein at least one of the channels exhibits a cross-sectional width in the cross-sectional plane, wherein the cross-sectional width is narrowest at an intersection of the channel and the second surface, and wherein the cross-sectional width increases along the longitudinal direction.

20. The mechanical interlocking die of claim 16, wherein a portion of one of the channels extends between the arm portion of at least one of the extrusion features and the first surface.

21. The mechanical interlocking die of claim 16, wherein for at least one of the extrusion features, the base portion comprises a height and the arm portion comprises a total length, wherein the total length of the arm portion is greater than the height of the base portion.

22. The mechanical interlocking die of claim 16, wherein for at least one of the extrusion features, the arm portion is a first arm portion, and wherein the extrusion feature further comprises a second arm portion extending at a second angle from the base portion.

23. The mechanical interlocking die of claim 22, wherein the first arm portion comprises a first length, wherein the second arm portion comprises a second length, wherein the base portion comprises a height, and wherein a sum of the first length and the second length is greater than the height of the base portion.

24. A method of extruding materials, the method comprising:
providing a mechanical interlocking die comprising:
a first surface and a second surface, the first surface and the second surface extending in a longitudinal direction;
a plurality of extrusion features, each extrusion feature comprising a base portion extending from the first surface, and an arm portion extending at an angle from the base portion; and
a plurality of channels, each channel extending at an angle to the longitudinal direction from the second surface, and wherein each channel is disposed between a pair of extrusion features;
extruding a portion of a first polymer layer through the extrusion features to form a plurality of ribs; and
extruding a portion of a second polymer layer through the channels, thereby substantially conforming the second material to the ribs, wherein substantially conforming the second material to the ribs mechanically interlocks the first polymer layer to the second polymer layer.

25. The mechanical interlocking die of claim 24, wherein the base portion of each extrusion feature extends in a cross-sectional plane from the first surface, wherein the arm portion of each extrusion feature extends at an angle in the cross-sectional plane from the base portion, and wherein the cross-sectional plane is substantially normal to the longitudinal direction.

26. The method of claim 24, wherein for at least one of the extrusion features, the base portion comprises a height and the arm portion comprises a total length, wherein the total length of the arm portion is greater than the height of the base portion.

27. The mechanical interlocking die of claim 24, wherein the height of the base portion of each of the extrusion features is less than or equal to about 10.0 millimeters.

28. The method of claim 24, wherein at least one of the extrusion features substantially defines a T shape in the cross-sectional plane.

29. The method of claim 25, wherein at least one of the extrusion features substantially defines a Y shape in the cross-sectional plane.

30. The method of claim 29, wherein at least one of the ribs substantially defines a T shape in a cross-sectional plane of the first polymer layer and the second polymer layer.

31. The method of claim 24, wherein the first polymer layer and the second polymer layer are coextruded.
